(19) United States
(12) Patent Application Publication
(10) Pub. No.: US 2014/0350320 A1
(43) Pub. Date: Nov. 27, 2014

(54) PROCESSING OF CHLORINE-CONTAINING CARBON-BASED RADIOACTIVE WASTE

(71) Applicant: ELECTRICITE DE FRANCE, Paris (FR)

(72) Inventor: Gerard Laurent, Villeurbanne (FR)

(21) Appl. No.: 14/365,360

(22) PCT Filed: Dec. 11, 2012
(86) PCT No.: PCT/FR2012/052883

§ 371 Date: Jun. 13, 2014

(30) Foreign Application Priority Data
Dec. 16, 2011 (FR) 11 61814

(51) Int. Cl. G21F 9/00; G21F 9/32

(52) U.S. Cl. CPC G21F 9/002; G21F 9/32
USPC 588/1; 110/237

(57) ABSTRACT

A system and method for processing of carbon-based radioactive waste, comprise at least: a) soaking in an acid solution, and b) a heat treatment, of a thermal shock type, said acid solution recovering radioactive material resulting from said waste at least after the implementation of step b).

The present invention relates to the processing of radioactive waste, based notably but not exclusively on graphite.

Decontamination of an irradiated graphite matrix may be carried out using a technique called “steam reforming” as defined notably in document U.S. Pat. No. 6,625,248. However, the technique presented in that document does not provide acceptable radioactive waste.

A solution to this problem was proposed in document WO-2010/103210, observing that only a first portion of the carbon in the graphite processed at a high enough temperature is radioactive, the carbon remaining in the graphite during processing being, as a function of the processing time, much less radioactive or not radioactive, so that the carbon dioxide resulting from its combustion may be discharged freely into the atmosphere.

The teaching in these two documents should permit sufficient decontamination with respect to carbon 14, chlorine 36 and tritium. As the other radionuclides are nonvolatile, they may be recovered in solid residues present at the end of the steam reforming step.

However, decontamination of chlorine 36 may prove more difficult than that of carbon as this radionuclide may be present in two forms:
a mineral form and
another form, which is organic.

This last-mentioned form, bound strongly to the graphite (notably by “aromatic” bonds of the type C—Cl), might not be released completely during processing by steam reforming.

Analyses of irradiated graphites by X-ray photoelectron spectrometry (XPS) have in fact shown the presence of two different chemical forms of chlorine in the graphite:
a form of chlorine described as “organic” chlorine, defined by C—Cl bonds characteristic of “aromatic carbon” (notably of the high-energy double bond type), and bound directly to the carbon of the carbon matrix usually forming the graphite, and
a form of chlorine called “mineral chlorine”, in the form of oxychlorides of indeterminate composition, probably localized in the porosity of the graphitic material (called “chlorite (ClO₂—) and chlorate (ClO₃—) compounds”).

The “organic” chlorine is strongly bound to the graphite and might not be released completely during processing by steam reforming, even modified by the teaching in document WO-2010/103210.

The present invention aims to improve the situation.

For this purpose, it proposes a method of processing carbon-based radioactive waste, comprising at least:

a) soaking in an acid solution, and

b) a thermal treatment, of the type of a thermal shock,

said acid solution recovering radioactive material from said waste at least after carrying out step b).

Possible embodiments of this method are briefly presented below.

For example, the acid solution may comprise sulfuric acid (H₂SO₄). Tests conducted with this type of acid have given good results.

It may be advantageous if the acid solution further comprises an element supplying oxygen in the acid solution, for example hydrogen peroxide (H₂O₂) in a range of proportions typically between 0.1% and 20% (a proportion of 5% having given good results, presented below).

Soaking in the acid solution may be carried out for a time range between 15 and 20 hours, for example about 18 hours.

The aforementioned thermal shock, carried out for example by roasting, may be carried out in a temperature range between 800 and 1200° C. (for example about 1000° C.), for a time between 15 and 30 minutes (for example about twenty minutes).

It was found, according to the tests that were carried out, that the radioactive material that escapes after step b) from the carbon-based waste (of the graphitic type) comprises at least chlorine 36. It very probably comprises practically all the “organic” chlorine defined above, since the tests carried out showed that practically all the chlorine 36 was in the solution after thermal shock, and therefore that it had practically been extracted completely from the carbon-based waste.

The present invention therefore makes it possible to extract chlorine 36, of the organic type, as demonstrated in the embodiment examples presented in detail below.

Since the invention makes it possible to recover this type of radioactive material (“organic” chlorine 36), it may therefore be employed advantageously in combination with processing by steam reforming, as explained above. Thus, processing of waste by the application of steps a) and b) of the method in the sense of the invention may be preceded or followed by a processing of the steam reforming type.

Thus, lixiviation of the radionuclides out of the irradiated graphite may be obtained by soaking in highly acidic and oxidizing solution, followed by thermal shock.

The present invention also relates to a plant for processing carbon-based radioactive waste, for carrying out the method as claimed in one of the preceding claims, characterized in that it comprises:
a tank for storing said waste in an acid solution, and
heating means configured for applying thermal shock to said waste after soaking in said acid solution.

Other advantages and features will become clear on reading the detailed description of embodiments presented as examples, and on examining the appended drawings in which:

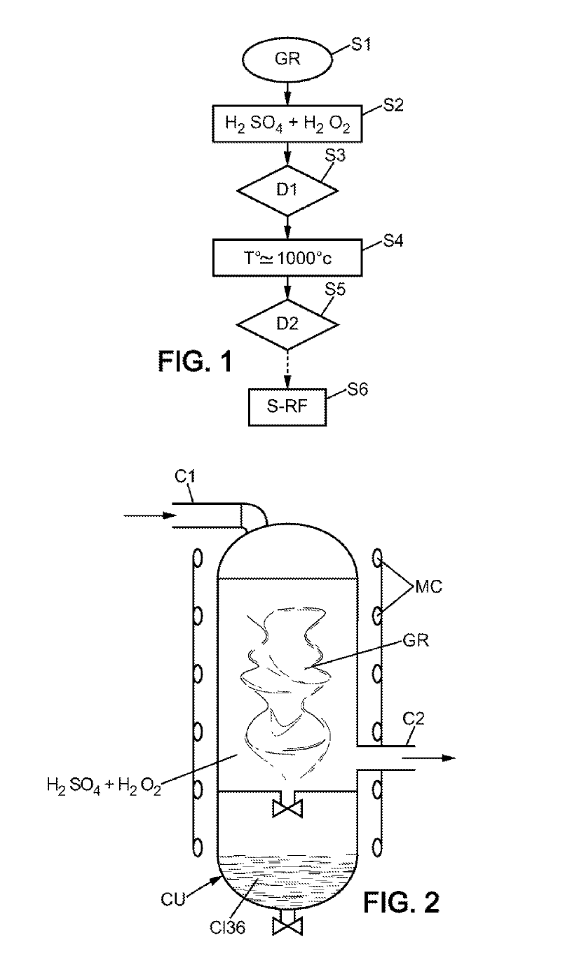

FIG. 1 illustrates schematically the main steps of the method in the sense of the invention, and

FIG. 2 illustrates schematically a plant for carrying out this method.

In embodiment examples given below, it is proposed to mix sulfuric acid (H₂SO₄) and hydrogen peroxide (H₂O₂) in suitable proportions (detailed in the embodiment examples given below) to determine their ability to release chlorine 36 from the graphite matrix.

### EMBODIMENT EXAMPLES

Four tests are presented in the following table, with hydrogen peroxide H₂O₂ as material supplying oxygen and sulfuric acid H₂SO₄ as acid medium and a distribution of about 4 to 20 volumes of acid (at 95%) to 1 volume of hydrogen peroxide (at 30%).

| H₂SO₄ (95%) | H₂O₂ (30%) |
|---|---|
| 19 mL | 1 mL |
| 18 mL | 2 mL |
| 17 mL | 3 mL |
| 16 mL | 4 mL |

Carbon-based radioactive waste was crushed to powder to constitute the various samples in the above table.

Each sample, having a mass of 5 grams and observed particle sizes distributed typically between 2380 and 4000 microns after crushing, was:
soaked for 18 hours in a solution of the aforementioned type (H₂SO₄ and H₂O₂),
then rinsed before being adjusted to neutral pH with 5% soda (NaOH),
then roasted:
   by rapid heating (in a range from 5 to 60 minutes, for example for 20 minutes), and
   at high temperature (between 900 and 1200° C., for example at 1000° C.).

After this treatment, it was observed that 90% of the chlorine 36 is released (in particular for the first sample—19 mL of acid to 1 mL of H₂O₂), with a tendency toward an improved yield on increasing in particular the concentration of acid.

### Other Observations

In addition, during processing, some characteristic features of behavior were observed. For example, for each test, 5 grams of carbon-based radioactive waste was added to a corresponding amount of solution (according to the above table) and was soaked for 18 hours. During this step, formation of bubbles was observed on the surface of the graphite particles.

It was also noted that the highest concentrations of H₂SO₄ in the soaking solution (i.e. the first sample above) had the effect of swelling the graphite. The pores of the latter absorbed a large proportion of the mass of the solution.

However, for the fourth sample in the above table, it was shown that swelling and penetration were very slight, compared to the first sample. The solutions collected were highly acidic and required neutralizing with 5% NaOH before analysis for determining the amount of radioactivity (Cl-36) that the solution had gained by lixiviation.

It was found that after soaking, the graphite mass increased significantly as the solution had penetrated into the pores of the graphite and had effectively caused it to swell.

The samples were then held at a temperature of 1000° C. for twenty minutes to extract any solution present in the pores of the graphite and thus extract all radioactivity. After twenty minutes, each sample was removed and collected for testing and to determine whether there were still significant amounts after soaking and roasting in the furnace.

It was observed after this thermal treatment that there was no large decrease of the initial graphite mass after soaking and subsequent roasting in the electric furnace at 1000° C. Moreover, examination of the percentage of total radioactivity captured shows that significant amounts of Cl-36 were lixiviated, especially in the first sample in the above table (with the highest proportions of H₂SO₄).

Finally, one of the most important findings is that the solution had captured 1080 Bq/g of Cl-36, or an amount very close to the initial value of Cl-36 that the graphite had before treatment (1200 Bq/g). Thus, after the treatment presented above as an example, there is still 10% of Cl-36 in the carbon-based radioactive waste.

FIG. 1 presents a summary of the main steps of the method in the sense of the invention, comprising:
for example, in a first step S1, recovery of carbon-based radioactive waste, for example in the form of graphite,
in the next step S2, soaking of this waste is begun in a highly oxygenated acid solution, for example sulfuric acid (H₂SO₄) with about 5% of hydrogen peroxide (H₂O₂);
after identifying a sufficient soaking time (for example 18 hours) in step S3,
application of a thermal treatment, by roasting, at a temperature of the order of 1000° C., in step S4;
after identifying a sufficient duration of thermal treatment (for example 20 minutes) in step S5,
the chlorine 36 may be recovered from the acid solution and treated separately, and the carbon-based waste for its part may then undergo processing by steam reforming as described for example in the document cited above, WO-2010/103210 (step S6).

The plant for carrying out this method may then comprise, referring to FIG. 2, a tank CU and a conveyor C1 of the carbon-based waste GR that is poured into a highly acidic, oxygenated solution (H₂SO₄—H₂O₂) contained in the tank CU, which is surrounded (in the example shown) by heating means MC for applying a treatment of the thermal shock type. The waste GR thus treated may then be recovered by the second conveyor C2 (after filtration, for example, of the acid solution now containing the chlorine-36) to be conveyed to a steam reformer. The chlorine 36 for its part may be recovered for example from the solution remaining under tank CU, as presented as a purely illustrative example in FIG. 2.

Moreover, the present invention is not limited to the embodiment presented above as an example; it applies to other variants.

Thus, it will be understood for example that another kind of acid may be provided in combination with or as a variant of sulfuric acid.

Moreover, hydrogen peroxide is a good element for supplying oxygen in a solution. However, as a variant of the embodiment presented above, it is possible for example to envisage bubbling of oxygen in the acid solution.

Thus, it will be understood that the proportions of the element supplying oxygen in the acid solution can be varied depending on the acids and elements used. Moreover, the soaking time in step a) can be varied. The same applies to the temperature and duration of thermal shock.

Finally, a particular embodiment is described above, in which the aforementioned step a) of soaking in the acid solution is preceded by crushing of the carbon-based waste to reduce it to powder. However, this application is not essential and it may be envisaged as a variant to soak the solid graphite directly for example to the core in an acid solution.

1. A method of processing carbon-based radioactive waste, comprising at least:
a) soaking the carbon-based radioactive waste in an acid solution, and
b) thermally treating, with a thermal shock, said acid solution recovering radioactive material from said waste at least after carrying out step b).

2. The method as claimed in claim 1, wherein the acid solution comprises sulfuric acid (H₂SO₄).

3. The method as claimed in claim 1, wherein the acid solution further comprises an element supplying oxygen to said solution.

4. The method as claimed in claim 3, wherein the acid solution comprises hydrogen peroxide (H₂O₂).

5. The method as claimed in claim 3, wherein the acid solution comprises an element supplying oxygen in a range of proportions between 0.1% and 20%.

6. The method as claimed in claim 3, wherein the acid solution comprises an element supplying oxygen in a proportion of 5%.

7. The method as claimed in claim 1, wherein soaking in the acid solution is carried out for a time range between 15 and 20 hours.

8. The method as claimed in claim 1, wherein the thermal shock is carried out in a temperature range between 800 and 1200° C.

9. The method as claimed in claim 1, wherein the thermal treatment is carried out for a time between 15 and 30 minutes.

10. The method as claimed in claim 1, wherein said radioactive material comprises at least chlorine 36.

11. The method as claimed in claim 1, wherein the processing of waste by the application of steps a) and b) is preceded or followed by a processing of the steam reforming type.

12. The method as claimed in claim 1, wherein step a) is preceded by crushing of the carbon-based waste to reduce it to powder.

13. The method as claimed in claim 1, wherein the thermal shock is carried out by roasting in step b).

14. A plant for processing carbon-based radioactive waste, for carrying out the method as claimed in claim 1, comprising:
a tank for storing said waste in an acid solution, and
a heater configured for applying thermal shock to said waste after soaking in said acid solution.
